(19) United States
(12) Patent Application Publication
(10) Pub. No.: US 2003/0120188 A1
(43) Pub. Date: Jun. 26, 2003

(54) Posture reforming tool

(76) Inventor: Toshihiko Kusumi, Niigata-ken (JP)

Correspondence Address: CONNOLLY BOVE LODGE & HUTZ LLP, SUITE 800, 1990 M STREET NW, WASHINGTON, DC, 20036-3425, US

(21) Appl. No.: 10/316,106

(22) Filed: Dec. 11, 2002

(30) Foreign Application Priority Data
Dec. 25, 2001 (JP) 2001-391705

(51) Int. Cl. A61H 1/00

(52) U.S. Cl. 601/115; 601/122; 601/136; 482/907

(57) ABSTRACT

To provide a novel posture reforming tool that may ensure the twist correction effect of the human body by a simple operation, a support portion that may support a back portion of a human body substantially in a horizontal condition without slanting the back portion of the human body on the right and left sides is provided on an upper portion of a tool body that may support at least an upper half body, the support portion having a longitudinal length in a direction of a length of the upper half body supported to the tool body, and a drop portion slanting downwardly at a steep angle is provided on the side that becomes the outside of extension of a length of the support portion.

### BACKGROUND OF THE INVENTION

The present invention relates to a posture reforming tool for correcting a twist of a human body.

In general, in many cases, a twist which is so called rotation is generated in a human body due to his or her life style or other factors. Such a distortion of the human body causes various diseases.

In order to improve such symptoms, there have been heretofore proposed a variety of reforming tools.

### SUMMARY OF THE INVENTION

An object of the present invention is to provide a novel posture reforming tool by which an excellent twist correcting effect may be obtained by simple operation.

According to a first aspect of the present invention, there is provided with a posture reforming tool characterized in that a support portion that may support a back portion of a human body substantially in a horizontal condition without slanting the back portion of the human body on the right and left sides is provided on an upper portion of a tool body that may support at least an upper half body, the support portion having a longitudinal length in a direction of a length of the upper half body supported to the tool body, and a drop portion slanting downwardly at a steep angle is provided on the side that becomes the outside of extension of a length of the support portion.

In the posture reforming tool according to the first aspect, according to a second aspect, when the human body is supported to said tool body so that a head portion is located on the side of the drop portion of the support portion, and the back portion of the human body is slid on the support portion toward the drop portion so that the back portion falls from the drop portion by its gravitational force, a back portion of a thoracic vertebra, a lumbar vertebra and pelvis is depressed against the support portion that is located on the side closest to the drop portion while kept substantially in the horizontal condition whereby a twist or a distortion of the thoracic vertebra, the lumbar vertebra and the pelvis may be corrected.

In the posture reforming tool according to the first aspect, according to a third aspect, the support portion is provided with the drop portion that is slanted in one direction of the longitudinal directions of the support portion and downward at a steep angle on the side of the support portion located on the uppermost slant portion.

Also, in the posture reforming tool according to the first aspect, according to the fourth aspect, the support portion is provided with the drop portion that is slanted in one direction of the longitudinal directions of the support portion and downward at a steep angle on the side of the support portion located on the uppermost slant portion.

Also, in the posture reforming tool according to the first aspect, according to a fifth aspect, right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

Also, in the posture reforming tool according to the second aspect, according to a six aspect, right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

Also, in the posture reforming tool according to the fourth aspect, according to a seventh aspect, right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

Also, in the posture reforming tool according to the first aspect, according to an eighth aspect, a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

Also, in the posture reforming tool according to the sixth aspect, according to a ninth aspect, a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

Also, in the posture reforming tool according to the seventh aspect, according to a tenth aspect, a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

Also, in the posture reforming tool according to the first aspect, according to an eleventh aspect, a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

Also, in the posture reforming tool according to the fourth aspect, according to a twelfth aspect, a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected, a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

In the posture reforming tool according to the ninth aspect, according to a thirteenth aspect, a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

In the posture reforming tool according to the tenth aspect, according to a fourteenth aspect, a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

In the posture reforming tool according to the first aspect, according to a fifteenth aspect, a plurality of support rollers are pivotally provided as the support portion that may support the back portion of the human body substantially in the horizontal condition without any slant on the right and left sides, the plurality of support rollers being juxtaposed in the longitudinal direction of the backbone of the back portion of the human body supported to the tool body, whereby the back portion of the human body supported to the support rollers may be slid in the longitudinal direction of the backbone by the rotational motion of the support roller, and the drop portion that is slanted at a steep angle is provided on the side that becomes outside of extension in the juxtaposition direction of the support rollers located most on one side out of the plurality of support rollers.

In the posture reforming tool according to the fourteenth aspect, according to a sixteenth aspect, a plurality of support rollers are pivotally provided as the support portion that may support the back portion of the human body substantially in the horizontal condition without any slant on the right and left sides, the plurality of support rollers being juxtaposed in the longitudinal direction of the backbone of the back portion of the human body supported to the tool body, whereby the back portion of the human body supported to the support rollers may be slid in the longitudinal direction of the backbone by the rotational motion of the support roller, and the drop portion that is slanted at a steep angle is provided on the side that becomes outside of extension in the juxtaposition direction of the support rollers located most on one side out of the plurality of support rollers.

A mode (how to embody the invention) will now be described together with the resultant effect.

At least the upper half body of the human body is supported on his or her back to the support portion of the tool body so that the head portion is located on the side of the drop portion.

Then, when the back portion of the human body is slid toward the drop portion and the back portion is dropped by the gravitational force subsequently to the drop of the head portion from the drop portion, the gravitational force of the portion falling from the drop portion is applied strongly downwardly so that the thoracic vertebra back portion is strongly depressed to the support portion just before the drop portion while the thoracic vertebra back portion is supported substantially in the horizontal condition without any slant on the right and left sides. As a result, the rotational motion is given to the twisted thoracic vertebra to be returned back to the normal condition to thereby correct the twist of the thoracic vertebra.

Subsequently, when the portion from the back portion to the waist portion is falling down from the drop portion, the lumbar vertebra and the pelvis are depressed substantially in the horizontal condition without any slant on the right and left sides to the support portion just before the drop portion in the same manner so that the rotational motion is given to the twisted lumbar vertebra and the twisted pelvis to be returned back to the normal condition to thereby also correct the twist of the lumbar vertebra or the pelvis.

Also, it is confirmed that, if this operation is repeated several times, not only is it possible to correct the twist of the human body on the right and left sides but also to correct the back-and-force twist of the pelvis.

Namely, the portion from the iliac crest to the hipbone is repeatedly strongly depressed against the support portion just before the drop portion so that the pelvis is gradually corrected symmetrically on the right and left sides.

Accordingly, it is possible to provide a posture reforming tool which is very much superior in practical use and which, only with the easy operation (action) of supporting the back portion of the human body simply on the support portion of the tool body and slidingly move the back portion toward the drop portion so that the back portion falls from the drop portion, may correct the twist of the thoracic vertebra, the lumbar vertebra and the pelvis.

Also, for example, the tray portion for supporting the lower half body of the human body is provided on the bottom portion of the tool body which is on the opposite to the drop portion, the heel retainer portion for retaining the heel of the leg is provided on the top portion of the tray portion, so that the back portion may be slid obliquely upwardly of the tool body by the force of the leg or legs while the heel or heels are being retained at the heel retainer portion, and the heel retainer portion is provided in a position where at least the human body is curved like an arc so that the head portion may fall down from the drop portion when the leg or legs are stretched while the heel or heels are retained at the heel retainer portion. It is therefore possible to correct the twist by oneself without any assistance from other. Thus, it is possible to provide a more practical posture reforming tool.

### BRIEF DESCRIPTION OF THE DRAWINGS

FIG. 1 is a perspective view showing a first embodiment.

FIG. 2 is an illustration showing a condition where an upper half body kept under the condition in the first embodiment is supported to a tool body, a lower half body is laid on a tray portion and a heel is retained at a heel retainer portion.

FIG. 3 is an illustration showing a condition where the knees are extended from the condition shown in FIG. 2 and the human body is bent like an arc.

FIG. 4 is an illustration showing a condition where the back portion is slid and the head portion falls from the drop portion from the condition shown in FIG. 3.

FIG. 5 is an illustration showing schematically a condition where the twist of the human body is being corrected.

FIG. 6 is an illustration showing schematically a condition where the back-and-forth twist of the pelvis is being corrected.

FIG. 7 is an illustration showing another use of the first embodiment.

FIG. 8 is a perspective view showing a second embodiment.

FIG. 9 is a perspective view showing a third embodiment.

### DESCRIPTION OF THE PREFERRED EMBODIMENTS

Embodiments of the present invention will now be described with reference to the accompanying drawings.

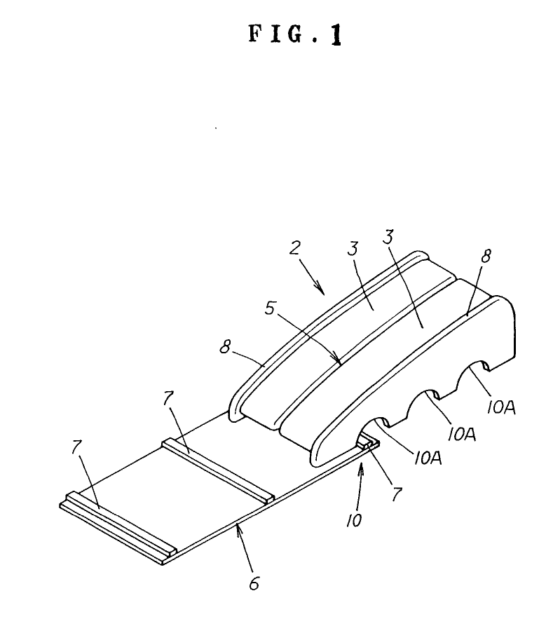

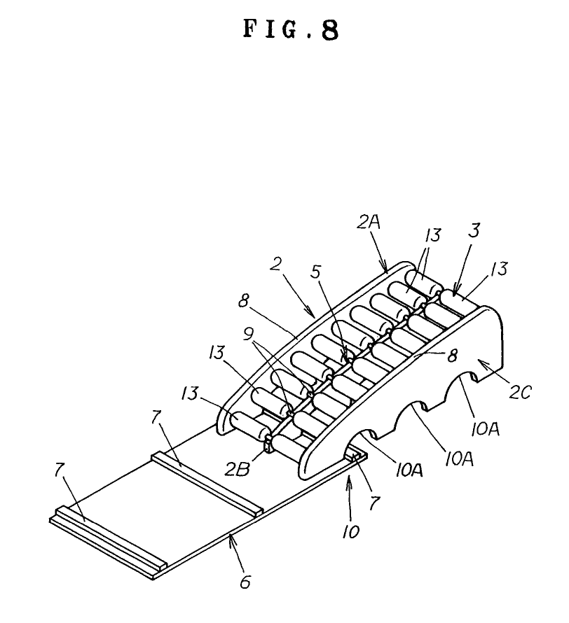

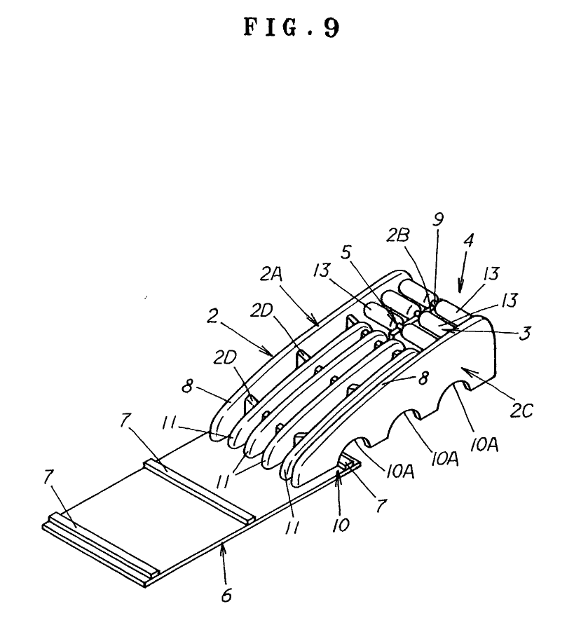

FIGS. 1 to 7 show a first embodiment, FIG. 8 shows a second embodiment and FIG. 9 shows a third embodiment, respectively.

The first embodiment will now be described.

A pair of support surface portions 3 that may support a back portion of a human body 1 in a substantially horizontal condition without any slant on the right and left sides are provided on an upper portion of a tool body 2 that may support an upper half of the human body on his or her back. The support surface portions 3 are adapted to have their longitudinal sides in a longitudinal direction of the upper half of the human body 1 supported on the tool body 2.

More specifically, the body 2 according to this embodiment is formed substantially into a box shape as shown in FIG. 1.

A pair of holder edge portions 8 are provided for projecting the right and left outer portions of the top surface of the tool body 2 upwardly so that the right and left projecting portions are brought into contact with the right and left portions of the back portion of the human body 1 to prevent the lateral displacement thereof. The support surface portions 3 are provided and juxtaposed on the right and left sides with respect to the position where the spine 12 of the back portion of the human body 1 supported on the above-described tool body 2 is to be located. A gap portion 5 is provided between the support surface portions 3 juxtaposed on the right and left sides. The back portion of the human body 1 may be supported on the tool body 2 with the spine 12 aligned with the gap portion 5 between the right and left support surface portions 3.

More specifically, a central portion along the longitudinal direction of the support surface portions is cut into a groove which is used as the gap portion 5.

Accordingly, because the gap portion is interposed between the support surface portions 3 juxtaposed on the right and left sides, the spine 12 is to be located in the gap portion 5 so that any unnecessary pressure will not be applied to the spine 12 without any pressure from the support surface portions 3. As a result, it is possible to prevent the spine 12 from being twisted or deformed due to the unnecessary pressure application to the spine 12.

Also, the support surface portions 3 juxtaposed on the right and left sides have drop portions 4 slanted in either one direction of the longitudinal direction of the support surface portions 3 and abruptly dropping at a sharp angle on the side of the support surface portions 3 on the uppermost slant side.

More specifically, the support portions 3 are formed to be slanted surfaces with the front sides lowered as shown in FIG. 1, and the top portions that are the extended outer sides in the longitudinal direction of the support surface portions 3 on the slanted upper side are formed to be the above-described drop portions 4 dropping downwardly substantially at a right angle.

Also, in this embodiment, the drop level of the above-described drop portion 4 from the support surface portions 3 located on the slanted uppermost side is set to a such a drop level that the gravitational force is easily applied when the head portion, the back portion and the waist portion of the human body 1 fall along and from the drop portion 4. The thoracic vertebrae, the lumbar vertebra and the pelvis are strongly depressed against the support surface portions 3 of the slanted uppermost portion by the gravitational force applied when the head portion, the back portion and the waist portion of the human body 1 fall along and from the drop portion 4, so that the twist and the distortion of the thoracic vertebrae, the lumbar vertebra and the pelvis may be corrected.

More specifically, the drop portion 4 is set to have a drop level of about 20 cm from a set surface of the tool body 2. Namely, in other words, the support surface portions 3 on the slanted uppermost side have a height of 20 cm from the set surface.

The height of 20 cm is the optimum height that has been ensured through the actual experiment made by the applicants. If the height is less than 20 cm, the effect of the gravitational force would become insufficient so that the reforming force would become insufficient, whereas if the height is greater than 20 cm, the gravitational force would largely affect dangerously and the tool body 2 per se becomes enlarged, disadvantageously.

Namely, as a result of the setup of the height to 20 cm, it is possible to obtain the extremely excellent reforming effect of the human body.

Also, in this embodiment, a footrest portion 6 for supporting a lower half portion of the human body 1 is projectingly provided on a bottom portion of the above-described tool body 2 on the opposite side to the above-described drop portion 4, and heel retainer portions 7 that may retain the heel portions of feet are provided on the top portion of the footrest portion 6 so that the back portion of the human body 1 may slidingly move on the slanted upper side of the above-described tool body 2 by the force of the leg or legs while the heel or heels are being retained at the heel retainer portion 7.

More specifically, in this embodiment, a rectangular plate member that has substantially the same size as that of the tool body 2 is used as the above-described footrest portion 6. The latter 6 may be adapted to be detachably mounted on the bottom portion of the tool body 2.

Also, a plurality of lateral rods are provided on a top surface of the footrest 6 and are used as the above-described heel retainer portions 7.

Also, explaining the detachable mechanism between the footrest portion 6 and the tool body 2, in this embodiment, the footrest portion 6 and the tool body 2 are coupled with each other through a positioning means 10 for positioning both the components in the alignment condition.

Explaining the positioning means 10, a plurality of cutaway retainer windows 10A are formed on the bottom portion of the tool body 2 in the longitudinal direction of the tool body 2, and one of the cutaway retainer windows 10A is retained at the associated heel retainer portion 7 so that the footrest portion 6 may be mounted on the tool body 2 under the alignment condition. Namely, the heel retainer portion 7 has the two functions for retaining the footrest 6 to the tool body 2 and for retaining the heels as expressed literally.

Also, the heel retainer portions 7 and the cutaway retainer windows 10A are both provided in a plurality of positions so that the projecting position of the footrest portion 6 to the tool body 2 may be changed in conformity with the statue of the user or the like and furthermore in no use, the footrest portion 6 may be received just under the tool body 2 to thereby save the space therefor.

Also, in this embodiment, the heel retainer portion 7 is provided in a position where at least the human body 1 may be curved like an arc with the head falls from the above-described drop portion 4 when the user extends his or her legs with his or her heels retained at the heel retainer portion 7.

The specific method of using the spinal reforming tool according to this embodiment will now be described.

As shown in FIG. 1, the cutaway retainer window 10A of the bottom portion of the tool body 2 is retained at a desired one of the heel retainer portions 7 of the footrest portion 6 laid on the set surface so that the tool body 2 is set in place.

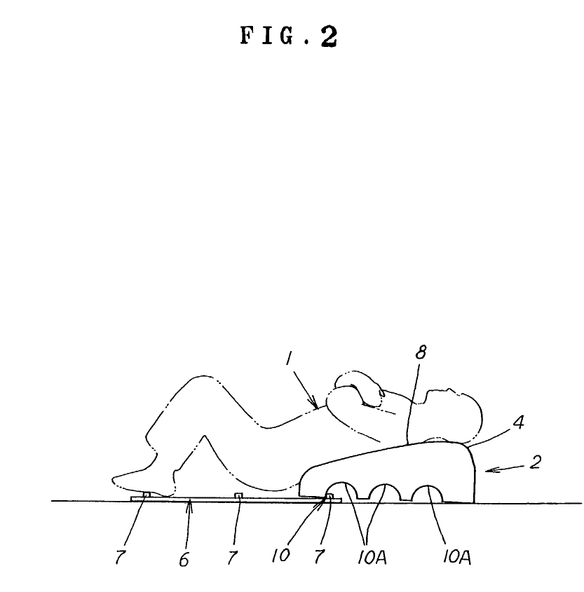

As shown in FIG. 2, the user lies on his or her back so that his or her lower half portion is laid on the footrest portion 6, bending his or her knees with his heels retained at the heel retainer portion 7, and the upper half human body is laid on the tool body 2 with his or her head located on the side of the above-described drop portion 4 of the support surface portions 3. At the same time, the spine 12 is located along the gap portion 5 between the right and left support surface portions 3.

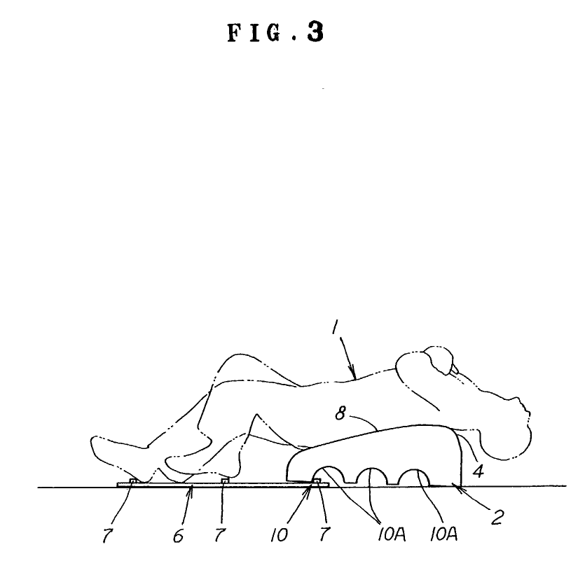

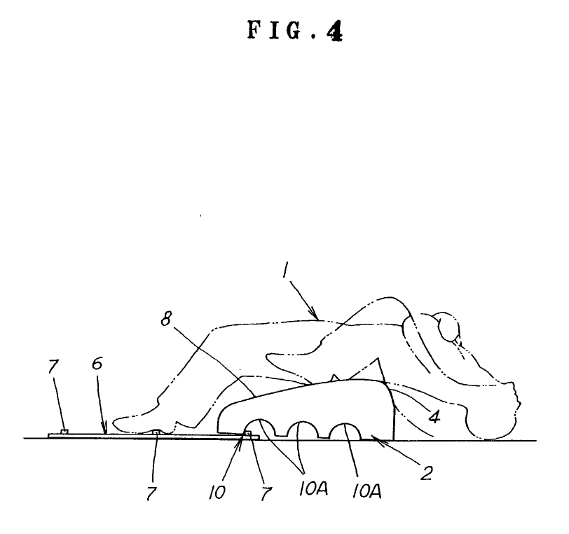

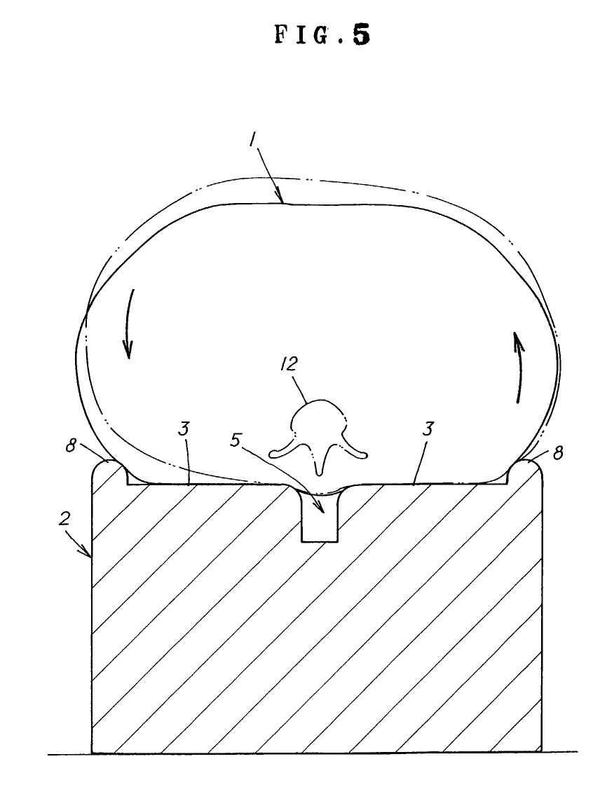

Subsequently, for example, both arms of the user are crossed with each other on his or her breast, and the user extends his or her knees so that the back portion of the human body 1 is slidingly moved on the slanted upper side of this tool body 2 (see FIG. 3). Furthermore, the back portion is slidingly moved while changing the heel retainer portion 7, at which his or her heels are retained, to another closer to the tool body 2. When the back portion falls by its gravitational force subsequently to the drop of the head along and from the drop portion 4 (see FIG. 4), the gravitational force is strongly applied downwardly to the portions falling along and from the drop portion 4. In this case, the thoracic vertebra portion is strongly depressed against the above-described support surface portions 3 of the slanted uppermost portion before the drop portion 4 while being held substantially in the horizontal condition. As a result, a rotational motion is given so that the twisted thoracic vertebrae are returned back to a normal condition to thereby impart the twist correction to the thoracic vertebrae (see FIG. 5).

Subsequently, when the portions from the back portion to the waist portion fall along and from the drop portion 4, in the same manner, the pelvis and the lumbar vertebra are depressed against the support surface portions 3 before the drop portion 4 while being held substantially in the horizontal condition so that the rotational motion is given to return the twisted pelvis and lumbar vertebra to the normal condition. Thus, it is possible to correct the twisted pelvis and the lumbar vertebra.

Also, it is confirmed that if this operation is repeatedly performed several times, it is possible to exhibit the correction effect not only for the right-and-left twist but also the back-and-forth twist of the pelvis.

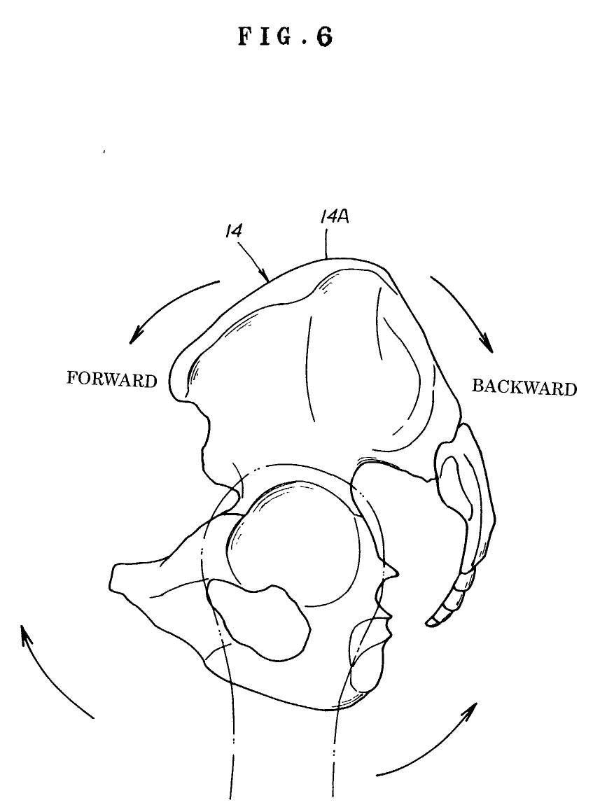

Explaining the back-and-forth twist of the pelvis herein, for example, the upper portion of the ilium 14 is shifted (twisted) backwardly so that, as shown in FIG. 6, the iliac crest 14A is higher than the Jacobi's line (the tentative line representing the highest portion of the iliac crest 14A in the normal condition). As a result, the thighbones are lifted to shorten the overall length of the legs. Inversely, the top portion of the ilium 14 is shifted (twisted) forwardly so that the overall length of the legs is extended.

Thus, when the above-described operation is repeated several times also to the pelvis that has been twisted back and forth by using the spinal correcting tool according to this embodiment, the portion from the iliac crest 14A to the innominate bone is rubbed against the support surface portions 3 before the drop portion 4 several times so that the pelvis is corrected gradually to the right-and-left symmetric shape.

It is possible to provide the spinal reforming tool that is extremely superior in practical use and that may correct the twist of the thoracic vertebrae, the pelvis and lumbar vertebra by the simple operation (action) of simply supporting the upper half portion of the human body on the support surface portions 3 of the tool body 2 with the human body on his or her back and causing the back portion to slidingly move toward the drop portion 4 and to fall along and from the drop portion 4.

Also, in the case where this operation is continuously repeated, it is preferable to return back to the original position while bending the elbows and the knees and gripping through the above-described cutaway retainer windows 10A with both hands under the condition that the back portion has been slid to the set surface. Namely, the cutaway retainer windows 10A are adapted to have a function as the hand gripper in this case.

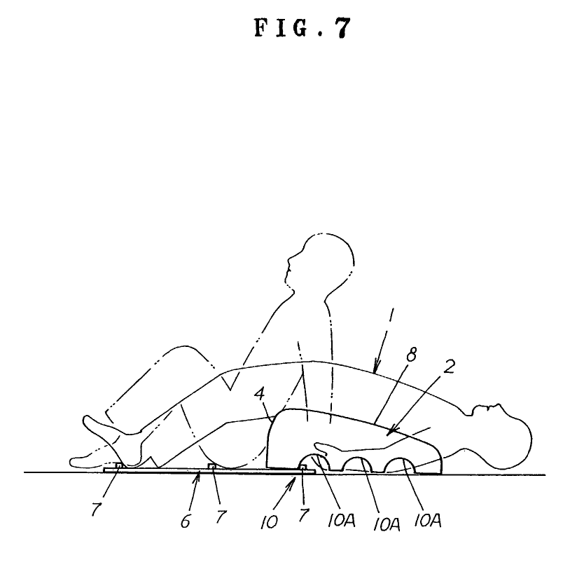

Also, FIG. 7 shows a state where the tool body 2 according to this embodiment is used in the revere direction as an example in a different use.

More specifically, first of all, the waist is applied to the drop portion 4, and the user bends his or her knees and sits on the hoot rest portion 6. The heels are retained at the heel retainer portion 7 and the hands grip the end portions of the outside two plate members 2A and 2C that are outside of the tool body 2.

Subsequently, the knees are expended to expand the breast outward. The human body is moved so as to rub the portion from the pelvis to the innominate bone against the drop portion 4.

This method of use works for correcting mainly the portion from the pelvis to the innominate bone. In this case, since the portion from the iliac crest 14A to the innominate bone is strongly rubbed several times against the drop portion 4, this is very effective in correcting the back-and-forth distortion (twist) of the pelvis.

The second embodiment will now be described.

According to this embodiment, support rollers 13 as support portions 3 that may support the back portion of the human body 1 substantially in the horizontal condition without any slant on the right and left sides are provided rotatably on the top portion of the tool body 2 that may support the upper half portion of the human body on its back. A plurality of support rollers 13 are juxtaposed in the longitudinal direction of the spine 12 of the human body 1 supported on the tool body 2. The back portion of the human body 1 supported on the support rollers 13 through the rotational operation of the support rollers 13 may be slide in the longitudinal direction of the upper half portion of the human body 1.

More specifically, as shown in FIG. 8, in the tool body 2 according to this embodiment, three base plate members 2A, 2B and 2C having a certain length are arranged longitudinally and substantially in parallel with each other at an interval. The respective base plate members 2A, 2B and 2C are coupled with each other by joint plate members disposed between the respective base plate members 2A, 2B and 2C. The tool body 2 has a length extending in the longitudinal direction perpendicular to the juxtaposed direction of the respective base plate members 2A, 2B and 2C.

The upper edge portions of the outer two base plate members 2A and 2C of the tool body 2 serve as the holder edge portions 8 for holding the right and left portions of the back portion of the human body 1 and preventing the portions from being displaced laterally by bringing the right and left portions into contact with the upper edge portions.

In this embodiment, pivot shafts 9 are provided substantially in the horizontal direction between the right and left outer base plate members 2A and 2C of the tool body 2. The pivot shafts 9 are provided at a plurality of positions at a predetermined interval in the longitudinal direction of the tool body 2. The above-described support rollers 13 are provided rotatably to the plurality of pivot shafts 9, respectively so that the support rollers 13 are juxtaposed over the overall region of the upper portion of the tool body 2.

More specifically, the base plate member 2B sandwiched between the right and left outer base plate members 2A and 2C is set at a lower height than that of the right and left outer base plate members 2A and 2C. The above-described pivot shafts 9 are provided substantially in the horizontal condition between the inner side surfaces of the upper portions between the right and left outer base members 2A and 2C extending outwardly of the central base plate member 2B so that the intermediate portions of the pivot shafts 9 are brought into contact with the top edge portion of the central base plate member 2B.

Also, the support rollers 13 are provided so that the right and left parts of the support rollers 13 are juxtaposed with respect to the portion where the spinal column 12 of the back portion of the body 1 supported to the tool body 2 is located. A gap portion is provided between the right and left juxtaposed support rollers 13 so that the back portion of the human body 1 may be supported to the tool body 2 with the spinal column 12 in alignment with the gap portion 5 between the right and left support rollers 13.

More specifically, the support rollers 13 are provided on the right and left parts with respect to the base plate member 2B in the central portion of the tool body 2 to form a two-row structure. Namely, the two right and left support rollers 13 are supported to one support shaft 9.

Accordingly, since the gap portion 5 is provided between the right and left juxtaposed support rollers 13, the spinal column 12 is located along the gap portion 5 so that no oppressive feeling by the support rollers 13 is given to the spinal column 12. It is possible to prevent the distortion or the twist of the spinal column 12 due to the application of the oppressive feeling to the spinal column 12.

Also, in this embodiment, the support rollers 13 are formed into round-rods. The above-described support shaft 9 is pivotally supported in a penetrated condition at the central portion of the round-rod-like support rollers 13 so that the circumferential surfaces of the support rollers 13 are kept substantially horizontally and the back portion of the human body 1 may be supported substantially horizontally to the support rollers 13.

Incidentally, the other structure is the same as that of the first embodiment.

A third embodiment will now be described.

This embodiment is directed to the case where, in the second embodiment, the number of the juxtaposed support rollers 13 is decreased.

More specifically, the third embodiment shows the case where the support rollers 13 are juxtaposed only at three positions from one end portion to the other end portion on the slanted upper portion of the tool body 2.

Also, in the portion of the tool body 2 where no support rollers 13 are provided, four plate-like support members 11 are provided substantially in parallel with each other at an interval in the longitudinal direction of the tool body 2. Joint members 2D are arranged between the respective plate-like support members 11 and between the base plate members 2A and 2C and the plate-like support members 11 so that the spinal column 12 may be located along the gap portion between the two plate-like support members 11 located on the central portion.

Accordingly, in the third embodiment, since the number of the support rollers 13 is small, the sliding effect of the back portion of the supported human body 1 is inferior to that of the second embodiment but the cost may be reduced corresponding to the reduction of the number of the support rollers 13 to make it possible to provide a less expensive product.

Incidentally, the present invention is not limited to these embodiments but it is possible to design the specific structure of each element as desired.

With the above-described structure, according to the present invention, it is possible to provide a novel posture reforming tool which is very much superior in practical use and which, only with the easy operation (action) of supporting the upper half of the human body simply on the support portion of the tool body and slidingly move the back portion toward the drop portion so that the back portion falls from the drop portion, may correct the twist of the thoracic vertebra, the lumbar vertebra and the pelvis.

Also, according to the second aspect of the present invention, it is possible to provide a posture reforming tool that is very much superior in practical use and which may well correct the twist of the thoracic vertebra, the lumbar vertebra and the pelvis while ensuring the above-described effect without fail.

Also, according to the third and fourth aspects of the present invention, since the human body is slid along and on the support rollers while bending his or her body backward like an ark, it is possible to provide a posture reforming tool that is superior very much in practical use and that may much better correct the posture while the gravitational force may be applied in an extremely good condition in the drop portion.

Also, according to the fifth to seventh embodiments, since the gap portion is provided between the right and left juxtaposed support portions, the spinal column is located along the gap portion to prevent the oppressive force due to the support portion to the spinal column. It is therefore possible to provide a posture reforming tool that is superior much better in practical use and that may prevent the spinal column from being twisted or distorted due to the application of the unnecessary oppressive force to the spinal column.

Also, according to the eighth to tenth aspects of the present invention, it is possible to provide a posture reforming tool that is superior much better in practical use and by which the twist correction of the posture is performed in a very good condition.

Also, according to the eleventh to fourteenth aspects of the present invention, it is possible to provide a posture reforming tool that is superior much better in practical use and which may perform the correcting operation only by himself or herself without any other assistance.

Also, according to the fifteenth and sixteenth aspect of the present invention, since the sliding movement of the human body may be extremely smoothly performed by the support rollers, it is possible to provide a posture reforming tool that is extremely superior in practical use and which may perform the posture reforming operation extremely easily.

What is claimed is:

1. A posture reforming tool characterized in that a support portion that may support a back portion of a human body substantially in a horizontal condition without slanting the back portion of the human body on the right and left sides is provided on an upper portion of a tool body that may support at least an upper half body, the support portion having a longitudinal length in a direction of a length of the upper half body supported to the tool body, and a drop portion slanting downwardly at a steep angle is provided on the side that becomes the outside of extension of a length of the support portion.

2. The posture reforming tool according to claim 1, wherein when the human body is supported to said tool body so that a head portion is located on the side of the drop portion of the support portion, and the back portion of the human body is slid on the support portion toward the drop portion so that the back portion falls from the drop portion by its gravitational force, a back portion of a thoracic vertebra, a lumbar vertebra and pelvis is depressed against the support portion that is located on the side closest to the drop portion while kept substantially in the horizontal condition whereby a twist or a distortion of the thoracic vertebra, the lumbar vertebra and the pelvis may be corrected.

3. The posture reforming tool according to claim 1, wherein the support portion is provided with the drop portion that is slanted in one direction of the longitudinal directions of the support portion and downward at a steep angle on the side of the support portion located on the uppermost slant portion.

4. The posture reforming tool according to claim 2, wherein the support portion is provided with the drop portion that is slanted in one direction of the longitudinal directions of the support portion and downward at a steep angle on the side of the support portion located on the uppermost slant portion.

5. The posture reforming tool according to claim 1, wherein right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

6. The posture reforming tool according to claim 2, wherein right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

7. The posture reforming tool according to claim 4, wherein right and left portions of the support portion supporting a backbone of the back portion of the human body supported to the tool body are juxtaposed to each other, and a gap portion is provided between the right and left portions of the support portion so that the back portion of the human body may be supported to the tool body with the backbone along the gap portion between the right and left portions of the support portion and with the back portion of the human body held substantially in the horizontal condition.

8. The posture reforming tool according to claim 1, wherein a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

9. The posture reforming tool according to claim 6, wherein a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

10. The posture reforming tool according to claim 7 wherein a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected.

11. The posture reforming tool according to claim 1, wherein a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

12. The posture reforming tool according to claim 4, wherein a drop difference of the drop portion from the support portion, located on the side closest to the drop portion, is set at a drop difference at which the gravitational force is likely to work when the head portion, the back portion or the waist portion falls from the drop portion, and a thoracic vertebra, a lumbar vertebra and a pelvis are strongly depressed against the support portion located most on the drop portion side by the gravitational force applied when the head portion, the back portion or the waist portion falls from the drop portion whereby a twist or a distortion of the thoracic vertebra, the lumbar vertebra and the pelvis is corrected, a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

13. The posture reforming tool according to claim 9, wherein a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

14. The posture reforming tool according to claim 10, wherein a tray portion for supporting a lower half body is provided on a bottom portion of the tool body that is the opposite side to the drop portion, and a heel retainer portion that may retain a heel portion of a leg is provided on an upper portion of the tray portion so that the back portion of the human body may be slid obliquely upwardly of the tool body by the force of the leg or legs while the heel is being kept to the heel retainer portion, and the heel retainer portion is provided in a position where the head portion may fall from the drop portion while at least the human body is curved like an arc when the leg is stretched while the heel is being retained at the heel retainer portion.

15. The posture reforming tool according to claim 1, wherein a plurality of support rollers are pivotally provided as the support portion that may support the back portion of the human body substantially in the horizontal condition without any slant on the right and left sides, the plurality of support rollers being juxtaposed in the longitudinal direction of the backbone of the back portion of the human body supported to the tool body, whereby the back portion of the human body supported to the support rollers may be slid in the longitudinal direction of the backbone by the rotational motion of the support roller, and the drop portion that is slanted at a steep angle is provided on the side that becomes the outside of extension in the juxtaposition direction of the support rollers located most on one side out of the plurality of support rollers.

16. The posture reforming tool according to claim 14, wherein a plurality of support rollers are pivotally provided as the support portion that may support the back portion of the human body substantially in the horizontal condition without any slant on the right and left sides, the plurality of support rollers being juxtaposed in the longitudinal direction of the backbone of the back portion of the human body supported to the tool body, whereby the back portion of the human body supported to the support rollers may be slid in the longitudinal direction of the backbone by the rotational motion of the support roller, and the drop portion that is slanted at a steep angle is provided on the side that becomes the outside of extension in the juxtaposition direction of the support rollers located most on one side out of the plurality of support rollers.
